(19) United States
(12) Patent Application Publication
(10) Pub. No.: US 2003/0007177 A1
(43) Pub. Date: Jan. 9, 2003

(54) Scan-to-cluster printing

(76) Inventor: Andrew R. Ferlitsch, Tigard, OR (US)

Correspondence Address: David C. Ripma, Patent Counsel, Sharp Laboratories of America, Inc., 5750 NW Pacific Rim Boulevard, Camas, WA, 98607, US

(21) Appl. No.: 10/208,122

(22) Filed: Jul. 29, 2002

Related U.S. Application Data
(63) Continuation-in-part of application No. 09/894,928, filed on Jun. 28, 2001.
Application No. 09/894,928 is a continuation-in-part of application No. 09/681,409, filed on Mar. 30, 2001.
Application No. 09/894,928 is a continuation-in-part of application No. 09/681,416, filed on Mar. 30, 2001.
Application No. 09/681,416 is a continuation-in-part of application No. 09/681,208, filed on Feb. 22, 2001.
(60) Provisional application No. 60/261,132, filed on Jan. 11, 2001.

(51) Int. Cl. B41B 1/00; G06F 15/00

(52) U.S. Cl. 358/1.15; 358/1.13

(57) ABSTRACT

A system and methodology for cluster printing, to plural printing devices. a document print job initiated by a scanning device. Employed for implementing this system and methodology, at a location in a data-communication path which exists effectively between the scanning device and a cluster of plural printing devices, is a print-job distributor which takes the form of at least one of (a) a cluster scan driver, (b) a cluster print driver, (c) a cluster spooler, (d) a cluster print processor, (e) a cluster multi-function printing (MFP) device, and (f) a cluster print assist. A user interface which is operatively connected to the print-job distributor enables user invocation of cluster printing in various manners.

### CROSS REFERENCE TO RELATED APPLICATIONS

This application is a continuation-in-part of application Ser. No. 09/894,928, filed Jun. 28, 2001, entitled “Methods and Systems for Page-Independent Spool File Sheet Assembly,” invented by Andrew Rodney Ferlitsch; which is a continuation-in-part of two applications, namely, application Ser. No. 09/681,409, filed Mar. 30, 2001, entitled “Methods and Systems for Print-Processor-Based Printer Status Detection and Print Task Distribution,” invented by Andrew Rodney Ferlitsch et al., and application Ser. No. 09/681,416, filed Mar. 30, 2001, entitled “Methods and Systems for Print-Processor-Based Print Task Error Recovery,” invented by Andrew Rodney Ferlitsch et al; both of which are continuations-in-part of application Ser. No. 09/681,208, filed Feb. 22, 2001, entitled “Methods and Systems for Print-Processor Modified Printing,” invented by Andrew Rodney Ferlitsch et al.; which claims the benefit of Provisional Patent Application Serial No. 60/261,132, filed Jan. 11, 2001.

### BACKGROUND AND SUMMARY OF THE INVENTION

This invention relates to printing, and in particular, to a method and system for variously distributing a print job to plural printers (printing devices) (a cluster) from a job origination which begins with a scanner, or a scanning device which forms part of another machine, such as a multi-function printing (MFP) device.

An issue which arises frequently in the computer printing “environment” involves the matter of duplicating a high volume of scanned images in a document print job in a manner which can employ more than the usual single printer to perform the printing task(s). Typically, scanning in of documents to be printed is carried out either by a stand-alone peripheral scanning device, or a scanning device which is part of a multi-function printing device (MFP hereinafter). No matter which category of these devices is employed, a problem arises when a high volume of copies of scanned images needs to be copied/printed in the most effective, minimum-time manner. Generally, each document image can only be copied, or printed, to a single printer, or to the marking engine in a single MFP device, or the like. Clearly, in the setting where other appropriate and compatible printers, and/or MFP devices with printing engines, are available, the typical process of calling for print-job completion from a single printer, or from an MFP with a marking engine, is an obvious underuse of available printing capacity.

Prior art approaches to solve this problem have not been very effective. For example, one prior art solution involves the adding to, say, an MFP device of special firmware which allows for the distribution of a print task to multiple printers. But such firmware is typically proprietary, and thus cannot be used with otherwise compatible printers which may come from a variety of different manufacturers.

The present invention addresses this issue in a unique and effective way by introducing, effectively, into the data-flow communication path that lies between a scanning device and a plurality of printers, MFP marking engines, or the like, a cluster-capable distribution functionality in the form of an appropriately modified scan driver, print driver, spooler, print processor, print assistant, or MFP driver. According to the invention, an appropriate scan-to-cluster, print-job distribution capability can be implemented via such normally always available intermediary componentry. Where the term “cluster” is used herein, that term is intended to refer to a plurality of printers, marking engines, and the like.

The several drawing views which accompany this text material graphically provide fully enabling disclosures to those skilled in the art. They do this completely with respect to a number of different effective implementations and modalities in relation to the present invention. All of the features and advantages of the unique system and approach of this invention, involving modified intermediate componentry and capability, as was just outlined above, will become very fully apparent as the following text is read in light of the several drawing figures.

### DESCRIPTION OF THE DRAWINGS

FIG. 1 is a block/schematic diagram illustrating generally the system and the methodology of the present invention. Solid lines depict features involving a stand-alone scanner and plural printers. Dashed lines reflect the capability to utilize a variable number of printers, etc. Dash-dot lines represent an arrangement involving a scanning device in a system possessing, inter alia, one (or more) MFP device(s) with marking engine(s)

FIG. 2 is a block/schematic diagram illustrating a scan-to-cluster embodiment of the present invention employing a stand-alone scanner, and a cluster spooler organized in accordance with the present invention.

FIG. 3 is a block/schematic diagram illustrating a scan-to-cluster embodiment of the invention employing a stand-alone scanner, and a cluster print processor organized in accordance with the present invention.

FIG. 4 is a block/schematic diagram of a scan-to-cluster embodiment of the invention employing a stand-alone scanner, and a cluster scan driver organized in accordance with the present invention.

FIG. 5 is a block/schematic diagram of yet another scan-to-cluster embodiment of this invention employing a stand-alone scanner, and a cluster print driver formed in accordance with the present invention.

FIG. 6 shows still a further scan-to-cluster embodiment of the invention employing, in a plural MFP setting, an MFP device which is equipped with a cluster MFP driver organized in accordance with the present invention.

FIG. 7 is a block/schematic diagram of another scan-to-cluster embodiment, also in a plural MFP setting, made in accordance with the present invention, and here employing a scanning MFP device, and also a cluster MFP driver organized in accordance with the present invention.

FIG. 8 is a block/schematic diagram of still a further multi-MFP scan-to-cluster embodiment of the invention employing a scanning MFP device, and a cluster spooler organized in accordance with the invention.

FIG. 9 is a block/schematic diagram of a scan-to-cluster embodiment of the invention, here employing, in the setting of plural MFP devices, a scanning MFP device, and a cluster print processor.

FIG. 10 is yet one more plural-MFP illustration of a scan-to-cluster embodiment proposed by the present invention employing a scanning MFP device and a cluster MFP driver.

FIG. 11 is a block, schematic diagram of another scan-to-cluster embodiment of the invention employing a stand-alone scanner, and a cluster print assistant, or assist, organized in accordance with the invention.

FIG. 12 shows one further system embodiment which is arranged, and which operates, in accordance with the present invention. This arrangement shows a multi-MFP scan-to-cluster organization which employs a cluster print assist.

### DETAILED DESCRIPTION OF THE INVENTION

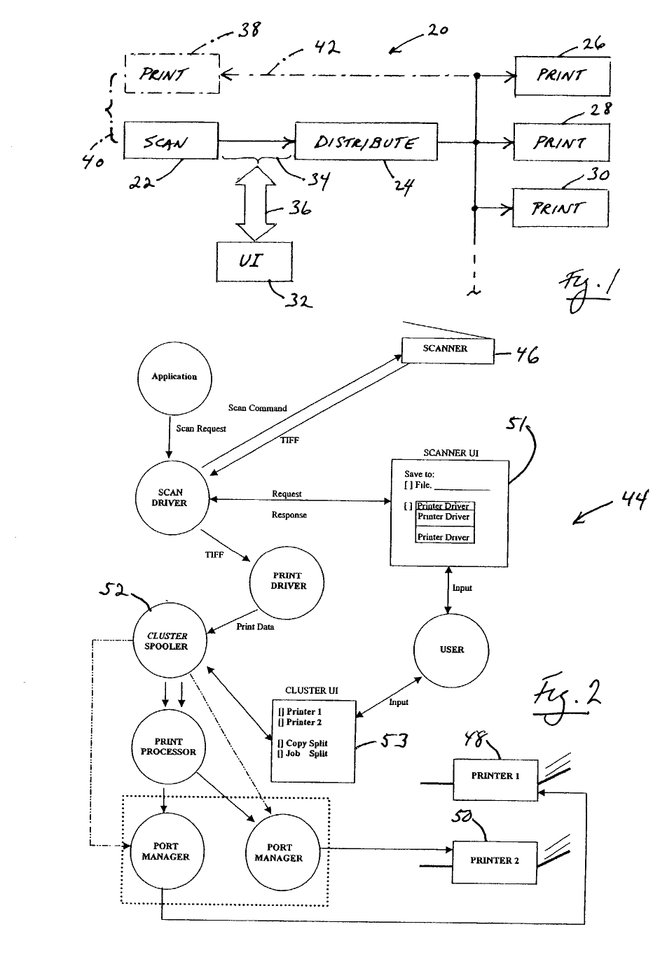

Turning attention now to the drawings, and referring first of all to FIG. 1, indicated generally at 20 is a scan-to-cluster document-printing system which is constructed in accordance with the present invention. FIG. 1 herein, in addition to showing schematically such a system, in fact can be viewed as a drawing which illustrates several embodiments of such a system, as well as several operating methodologies which are offered by the invention. As will be explained, the solid lines, the dashed lines, and the dash-dot lines, in this figure operate in slightly different ways. More particularly, the solid lines generally picture a system arrangement which includes a stand-alone scanner, and a plurality of printing devices which are organized into a cluster in accordance with the present invention. The dashed line generally points out the fact that the system and methodology of this invention can accommodate scan-to-cluster printing to different plural numbers of printers, only a few of which are directly pictured in FIG. 1. The dash-dot lines represent an overall modification of the system and associated methodology wherein there are employed at least one MFP device, and also a plurality of printers, or printing devices, one of which may take the form of a marking engine in at least one MFP device.

And so, illustrated within system 20 in FIG. 1, at 22, is a stand-alone scanner, or scanning device, which is employed, according to the invention to scan in various documents for printing. Scanning device 22 is effectively connected through what is referred to herein as a print-job distributor 24 to a plurality of potentially available printing devices, such as the three printers shown at 26, 28, 30. These printers, or printing devices, may themselves be stand-alone peripheral devices, or one or more of them might be a marking engine, or the like, in a device such as an MFP device. The communication path which thus exists between scanning device 22 and printers 26, 28, 30 constitutes a path herein wherein, in accordance with the invention, the opportunity for scan-to-cluster printing is made possible via a user interface which is shown at 32 in FIG. 1. User interface 32 herein is a computer-like display screen which offers certain control options (interactively) by a user with system 20. This user interface is effectively connected in system 20, in the region of scanning device 22 and print-job distributor 24, as is generally indicated by (a) a bracket 34, and (b) a double-arrow-ended data link 36.

As will be shown and discussed more specifically with the remaining drawing figures, print-job distributor 24 may take any one of several specific forms herein, which forms include a cluster scan driver, a cluster print driver, a cluster spooler, a cluster print processor, a cluster print assist, or assistant, and a cluster MFP driver. Accordingly, block 24 can be viewed in an appropriate number of different ways to be interpreted as one of these several cluster-distribution components and practices in system 20.

In very general terms, a user appropriately feeds a document, or documents, for scanning in by scanning device 22. When this has occurred, the user is furnished, on user interface 32, the opportunity to invoke cluster printing so as to have the scanned-in print job distributed in various ways, and in a shared manner, to an appropriate cluster of available plural printers, such as the printers shown in FIG. 1 at 26, 28, 30. The user is also offered the opportunity, via user interface 32, to call for certain image-processing and/or formatting possibilities respecting a scanned-in print job, including differentiating possibilities (that differ from printer to printer) which are associated, respectively, with different ones of the selected printers in the cluster.

Still considering what is show in FIG. 1, and now referring to a generally modified form of the system wherein print-job initiation takes place through the scanning device in an MFP device, here, we consider the presence in FIG. 1 of the elements shown in dash-dot lines. In this modification, block 22, and a dash-dot block 38, form portions of a single MFP device which is illustrated generally by dash-dot bracket 40. Dash-dot line 42 reflects the fact that block 38, which is a marking engine that forms part of MFP device 40, is involved as one of the plural cluster of printing devices made available, in accordance with this invention, for scan-to-cluster, print-job printing.

Looking at FIG. 1 now as a diagram which also illustrates several versions of the unique methodology, offered by the present invention, such methodology generally includes, in a system such as that shown in FIG. 1, and with respect to that system, (1) furnishing a print-job distributor which is capable of delivering a print-job in various manners to a selected cluster of printers, or printing devices, such as those shown at 26, 28, 30, 38, and (2) utilizing an appropriate operatively connected user interface, such as that represented by block 32, to enable user invocation of cluster printing to those printers.

The various illustrations now to be described in conjunction with the other drawing figures fit squarely within the overall picture presented in FIG. 1, with each of these illustrations picturing at least one embodiment, and at least one practice modality, which characterize the present invention. In many instances, the general system arrangements shown in these other drawing figures are described hereinbelow in manners which point out plural possible modifications, referred to as other, or additional, embodiments.

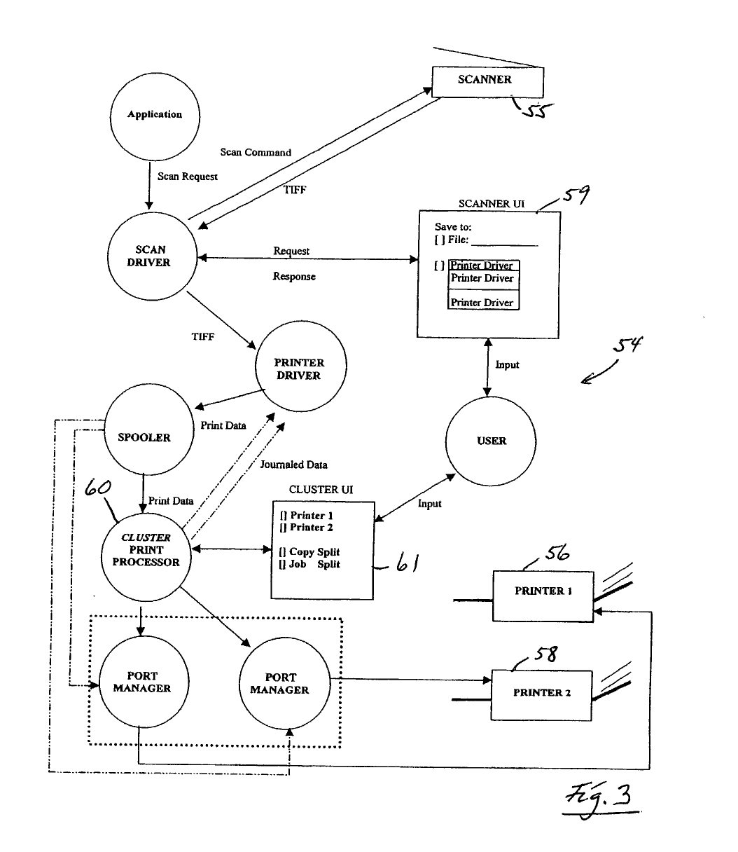

### The FIG. 2 Embodiment (s)

FIG. 2 in the drawings illustrates what is referred to herein as a system which implements a methodology of scan-to-cluster activity involving a stand-alone scanner, and a cluster spooler. This embodiment is indicated generally at 44 in FIG. 2. A scanner which is employed in the system of FIG. 2 is shown at 46, the cluster of plural printers which are involved is shown as including two printers 48, 50, and located in the data-communication path which lies between scanner 46 and printers 48, 50 is a cluster print-job distributor which herein takes the form specifically of a cluster spooler shown at 52. A user interface which allows a user to invoke cluster printing is shown at 51.

In this embodiment, the user places the image(s) to be scanned on and within the scanning station that is furnished in scanner 46. Stand-alone scanner 46 may a simplex or duplex scanner, and may have a document feeder.

The user initiates the scan by invoking a scan driver, such as a TWAIN driver. The scan driver reads from the scanner the scanned image(s) data (e.g., TIFF) which may be further manipulated (image manipulation herein) by the driver to perform tasks such as: cropping, zooming, rotating, compressing, color adjusting, and diffusing. In addition to offering the above commands, the scan driver may allow the user to select sending the scanned image(s) data (e.g., TIFF) to a specified print driver. In an alternative embodiment, the scan driver and print driver are selected from a common menu, such as in an imaging application (i.e., Adobe PhotoShop), where scanned image(s) data (e.g., TIFF) is brought into the application, optionally further manipulated, and selectively sent to a specific print driver.

In related, modified embodiment, the scanned image(s) data may be further manipulated by conversion into other compatible forms (image formatting herein), such as JPEG and Raster Bitmaps, or translated, such as Optical Character Recognition (i.e., OCR), or segmented, such as text/image separation (i.e., Banding) and color/b&w separation (i.e., Color Collating).

The print driver converts the post-manipulated scanned image(s) data into printer ready data for the specified device(s). The specified printing device takes as input the scanned image(s) data. For example, the printing device's marking engine may take as input a/an (un)compressed bitmap format, such as TIFF, where no conversion is required. In an alternative environment the print driver converts the scanned image(s) data into a PDL format compatible with the printing device (e.g., PCL, Postscript). In a third embodiment, the print driver-may journal the scanned image(s) data for deferred playback into printer ready data (e.g., EMF in the Microsoft Operating systems).

The printer ready data from the printer is then sent to a print spooler for despooling to the printing device(s).

In this form of the invention, the print spooler (52) has printer clustering capabilities (Cluster Spooler), and displays a dialog through another interface shown at 53. Clustering capabilities may include copy splitting, job splitting, job separating, load balancing, intelligent routing, printer error recovering and job relocating.

The print spooler displays to the user a dialog for selecting one or more printing device(s) and cluster options. In other embodiments, the cluster options and printing device(s) may be pre-configured, or set by an application, or automated, or made responsive to commands in the input print data stream.

The print spooler modifies the print data stream according to the cluster options, and routes the modified print data stream(s) to the specified printer(s). For example, the user might have selected splitting one-hundred copies (i.e., Copy Splitting) of a scanned image evenly across two printers (e.g., fifty copies/printer) 48 and 50. The print spooler could modify the print data stream to print copies, and then send the same print data stream to both printers 48 and 50. The modified print data stream(s) could either be written to the port manager(s) of the specified printers, or passed onto a print processor, which would write the print data stream(s) to the port manager(s) (i.e., printer ready data), or if journaled data, played back the print data stream(s) to the corresponding print driver(s), which would subsequently render the journaled data into printer ready data and pass to the printer spooler for despooling to the specified printing device(s).

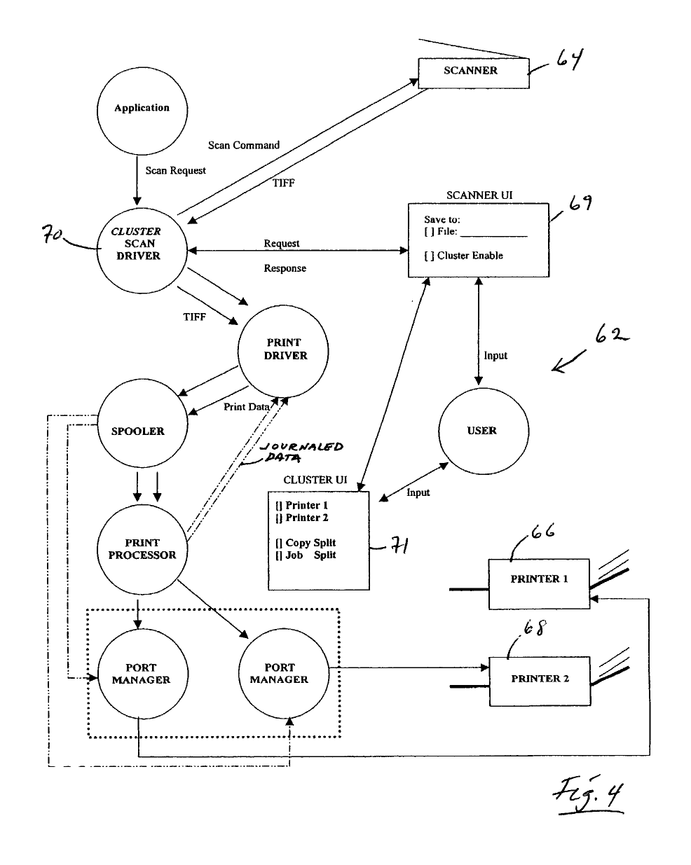

### The FIG. 3 Embodiment(s)

FIG. 3 illustrates a modified form 54 of the invented system which is referred to herein as a scan-to-cluster, stand-alone scanner system employing a cluster print processor. The single scanner employed is shown at 55. The plurality of printers which are organized into a cluster is shown as including printers, or printing devices, 56, 58, and acting as a print-job cluster distributor between scanner 55 and printers 56, 58 is a cluster print processor 60. Two user interfaces are shown at 59,61.

In this embodiment, the user places the image(s) to be scanned on a stand-alone scanner. The stand-alone scanner may be a simplex or duplex scanner, and may have a document feeder.

The user initiates a scan by invoking a scan driver, such as a TWAIN driver. The scan driver reads from the scanner the scanned image(s) data (e.g., TIFF) which may be further manipulated by the driver to perform tasks such as: cropping, zooming, rotating, compressing, color adjusting, and diffusing. In addition to offering the above commands, the scan driver may allow the user to select sending the scanned image(s) data (e.g., TIFF) to a specified print driver. In an alternative embodiment, the scan driver and print driver are selected from a common menu, such as an imaging application (i.e., Adobe PhotoShop), where scanned image(s) data (e.g. TIFF) is brought into the application, optionally further manipulated, and selectively sent to a specified print driver.

In another embodiment, the scanned image(s) data may be further manipulated by conversion into other compatible formats, such as JPEG and Raster Bitmaps, or translated, such as Optical Character Recognition (i.e., OCR), or segmented, such as text/image separation (i.e. Banding) and color/b&w separation (i.e., Color Collating).

The print driver converts the post-manipulated scanned image(s) data into printer ready data for the specified printing device(s). In one embodiment, the printing device may take as input a/an (un)compressed bitmap format, such as TIFF, where no conversion is required. In an alternative environment, the print driver converts the scanned image(s) data into PDL format compatible with the printing device (e.g., PCL, Postscript).

In a third embodiment, the print driver may journal the scanned image(s) data for deferred playback into printer ready data (e.g., EMF in the Microsoft Operating systems).

The printer ready data from the print driver is then sent to a print spooler for despooling to the printing device(s). The print spooler then despools the print data stream to a print processor.

In this form of the invention the print processor (60) has printer clustering capabilities (Cluster Print Processor), and displays a dialog at interface 61. Clustering capabilities may include: copy splitting, job splitting, job separating, load balancing, intelligent routing, printer error recovering and job relocating.

The print processor displays to the user a dialog for selecting one or more printing device(s) and cluster options. In other embodiments, the cluster options and printing device(s) may be pre-configured, or set by an application, or automated, or be made responsive to commands in the input print data stream.

The print processor modifies the print data stream according to the cluster options, and routes the modified print data stream(s) to the specified printer(s). For example, the user might have selected splitting one-hundred copies (i.e., Copy Splitting) of scanned images evenly across two printers (e.g., fifty copies/printer) 56 and 58. The print processor could modify the print data stream to print fifty copies, and then send the same print data stream to both printers, 56 and 58. The modified print data stream(s) could either be written to the port manager(s) of the specified printers, or if journaled data, played back as modified print data stream(s) to the corresponding print driver(s), which would subsequently render the journaled data into printer ready data and pass to the print spooler for despooling to the specified printing device(s).

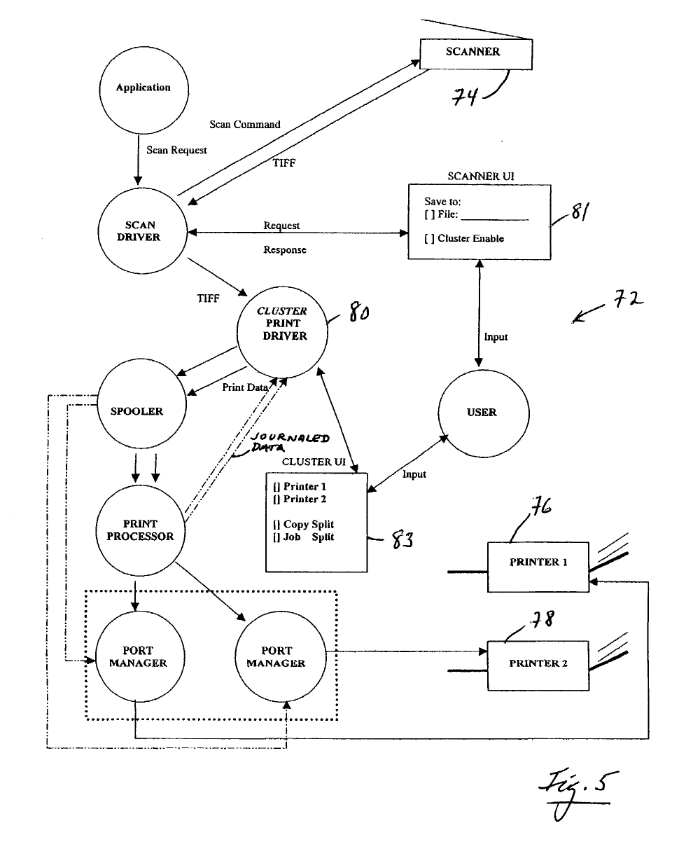

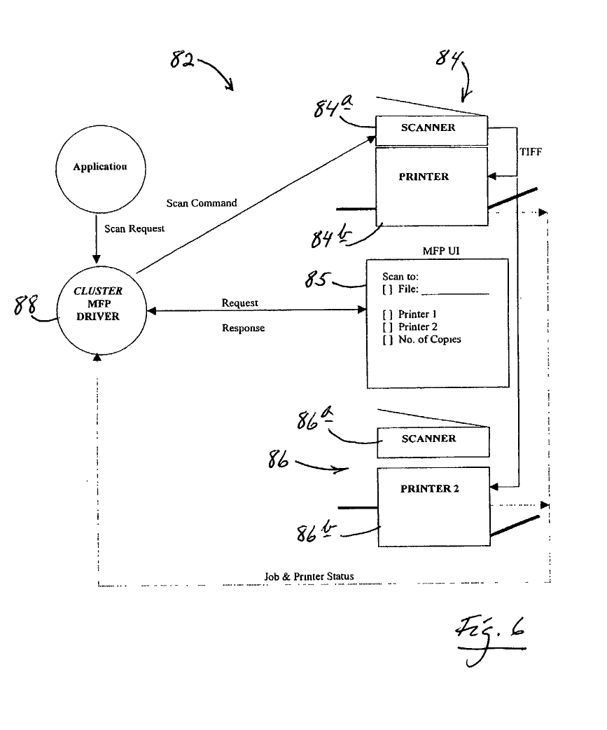

### The FIGS. 4 and 5 Embodiment(s)

Still another embodiment of the invention, which is referred to herein as a scan-to-cluster, stand-alone scanner system employing a cluster scan driver, is shown in FIG. 4 generally at 62. Included in system 62 is a stand-alone scanner 64, a pair of printers labeled 66, 68, and located in the communication data path between this scanner and these printers a cluster scan driver 70 configured in accordance with the present invention. Also included are two user interfaces shown at 69, 71.

Described herein now, along with the system which is shown at 62 in FIG. 4, is a system which is shown at 72 in FIG. 5. System 72, as was true with respect to previously-mentioned system 62, includes a stand-alone scanner 74, and a cluster plurality of printers, or printing devices, including the two shown at 76, 78 in FIG. 5. Operating in accordance with the present invention as a cluster print-job distributor between scanner 74 and printers 76, 78 is a cluster print driver 80 which is configured, and which operates in accordance with, this pictured embodiment of the system and methodology of the present invention. Two user interfaces are shown at 81, 83.

In this embodiment, the user places the image(s) to be scanned on the stand-alone scanner. This scanner may be a simplex or duplex scanner, and may have a document feeder.

The user initiates a scan by invoking a scan driver, such as a TWAIN driver. The scan driver reads from the scanner, the scanned image(s) data (e.g., TIFF) which may be further manipulated by the driver to perform tasks such as: cropping, zooming, rotating, compressing, color adjusting, and diffusing. In addition to offering the above commands, the scan driver may allow the user selectively to send the scanned image(s) data (e.g., TIFF) to a specified print driver. In an alternative embodiment, the scan driver and print driver are selected from a common menu, such as an imaging application (i.e., Adobe PhotoShop), where the scanned image(s) data (e.g., TIFF) is brought into the application, optionally further manipulated, and selectively sent to a specified print driver.

In another embodiment, the scanned image(s) data may be further manipulated by conversion into other compatible formats, such as JPEG and Raster Bitmaps, or translated, such as Optical Character Recognition (i.e., OCR), or segmented, such as text/imaging separation (i.e. Banding) and color/b&w separation (i.e., Color Collating).

The print driver converts the post-manipulated scanned image(s) data into printer ready data for the specified printing device(s). In one embodiment, a printing device takes as input the scanned image(s) data. For example, the printing device's marking engine may take as input a/an (un)compressed bitmap format such as TIFF, where no conversion is required. In an alternative environment, the print driver converts the scanned image(s) data into a PDL format compatible with the printing device (e.g., PCL, Postscript).

In a third embodiment, the print driver may journal the scanned image(s) data for deferred payback into printer ready data (e.g., EMF in the Microsoft Operating systems).

In this style of system, the scan (70) or print (80) driver has printer clustering capabilities and displays a dialog. Clustering capabilities may include: copy splitting, job splitting, job separating, load balancing, intelligent routing, printer error recovering and job relocating.

The scan driver displays to the user a dialog for selecting one or more printing device(s) and cluster options. In other embodiments, the cluster options and printing device(s) may be configured, or set by an application, or automated, or be made responsive to embedded commands in the input scanned image(s) data.

The scan driver (70) modifies the scanned image(s) data stream according to the cluster options, and routes the modified scanned image(s) data stream to the specified printer(s). For example, the user might have selected splitting one-hundred copies (i.e., Copy Splitting) of a scanned image evenly across two printers (e.g., fifty copies/printer) 66 and 68. The scan driver could modify the scanned image(s) data stream to print fifty copies, and then to send the same scanned image(s) data stream to both printers 66 and 68. The modified scanned image(s) data stream would be passed to the respective print driver(s). The print driver(s) would render the scanned image(s) data into printer ready data, or journaled data for deferred playback, and pass the print data stream(s) to the print spooler for despooling to printers 66 and 68.

In an alternative embodiment, the print driver (80) would have the clustering capabilities for delivery to cluster printers 76, 78.

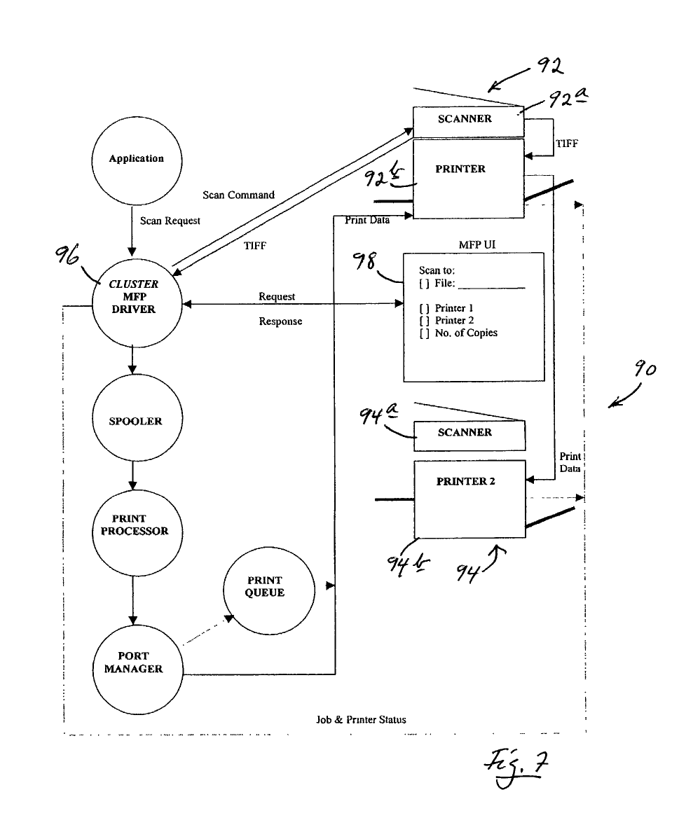

### The FIG. 6 Embodiment(s)

In FIG. 6, there is shown generally at 82 yet another modified form of a system made in accordance with the present invention. This system is referred to herein as a scan-to-cluster, MFP, firmware system. Included in system 82 are two MFP devices shown generally at 84, 86. Within device 84 is a scanner, or scanning device, 84a, and an associated marking engine which is labeled “PRINTER” and designated 84b in FIG. 6. Within MFP device 86 is a scanner, or scanning device, 86a, and an associated marking engine 86b. In system 82, it is scanner 84a which a user employs to scan in documents for printing. Such scanned documents, in accordance with practice of this invention, are distributed through a print-job cluster distributor which takes the form of a cluster MFP driver shown at 88 in FIG. 6. The plural printers which are formed into a cluster (according to the invention) in the system illustrated in FIG. 6 includes printers, or marking engines, 84b and 86b. A user interface is shown at 85 in system 82.

In this embodiment, the user places the image(s) to be scanned on an MFP (84) device. The scanning unit of the MFP device may be a simplex or duplex type, and may have a document feeder. MFP device 84 has a firmware based clustering capability.

The user initiates a scan by invoking the MFP driver which contains the scan driver for the corresponding MFP.

In this version of the invention, the MFP driver has the ability to specify clustering options, and the MFP firmware has a command language for interpreting clustering options from the MFP driver. For example, the user might have selected splitting one-hundred copies (i.e., Copy Splitting) of a scanned image evenly across two printers (e.g., fifty copies/printer) 84b and 86b. The MFP driver would initiate a sequence of commands to the MFP to scan the image(s), print one-hundred copies of the scanned image, and evenly distribute the print job between printers 84b and 86b. In this example, the first MFP would send a duplicate copy of the scanned image(s) data to the second MFP through a connection, such as a local, network, or remote connection, and instruct the second MFP to print fifty copies. PJL code for a command sequence might look like this:

| | |
|---|---|
| Esc%-12345 | #Universal Printer Language |
| | Exit |
| EscE | #Printer Reset |
| @PJL SCAN | #Scan Image(s) |
| @PJL SET COPIES = 100 | #Number of Copies to Print |
| @PJL SET COPY SPLIT = ON | #Select Copy Splitting |
| @PJL SET LOAD BALANCE = EQUAL | #Distribute Print Job Equally |
| @PJL SET CLUSTER = “P1, P2” | #Printer Cluster |

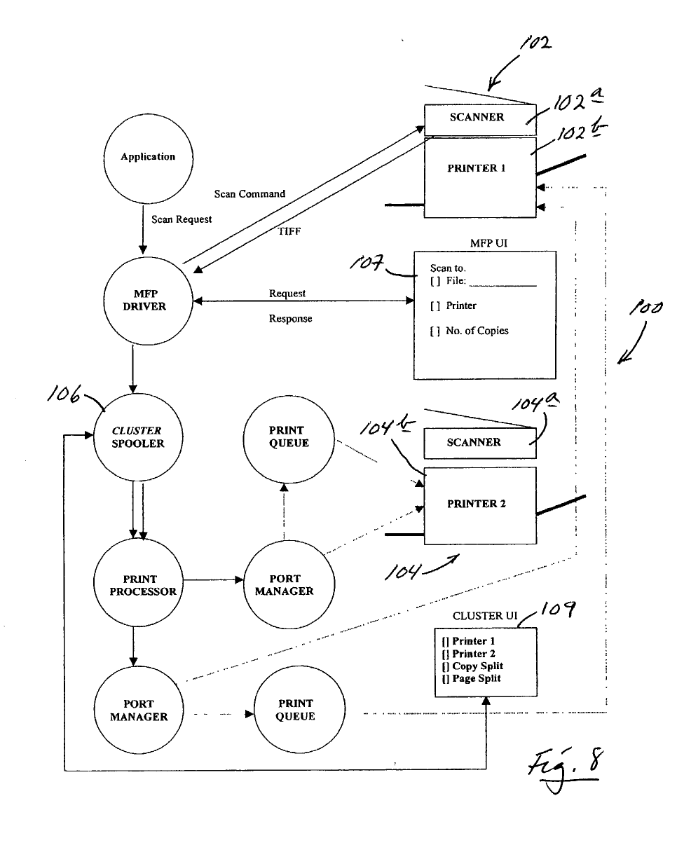

### The FIG. 7 Embodiment(s)

Turning attention now to FIG. 7, here indicated generally at 90 is still a further system embodiment of the present invention which is referred to herein as a scan-to-cluster, MFP, firmware-via-spooler system. Included in system 90 are two MFP devices 92, 94 which include, respectively, scanners, or scanning devices, 92a, 94a, and printers, or print marking engines, 92b, 94b, respectively. Operatively interposed in the data communication path pictured in FIG. 7, and operating in this system as a cluster job-print distributor, is a cluster MFP driver shown at 96. Also included in system 90 is an appropriate user interface shown generally at 98 in FIG. 7.

In system 90, it is scanner 92a which is employed nominally to scan in documents for printing.

In this embodiment, the user places the image(s) to be scanned on MFP 92. The scanning unit of the MFP may be a simplex or duplex type, and may have a document feeder.

The user initiates a scan by invoking the MFP driver which contains both the scan driver and print driver for the corresponding MFP. The MFP scan driver reads from the scanner the scanned image(s) data (e.g., TIFF) which may be further manipulated by the driver to perform tasks such as: cropping, zooming, rotating, compressing, color adjusting, and diffusing. In one embodiment, the MFP driver may further manipulate the scanned image(s) data. In another embodiment, the MFP driver may pass the scanned image(s) data to an application (e.g., Adobe PhotoShop) for further manipulation.

In another embodiment, the scanned image(s) data may be further manipulated by conversion into other compatible forms, such as JPEG and Raster Bitmaps, or translated, such as Optical Character Recognition (i.e., OCR), or segmented, such as text/image separation (i.e., Banding) and color/b&w separation (i.e., Color Collating).

The MFP driver (96) converts the post-manipulated scanned image(s) data into printer ready data for the specified printing device(s). In one embodiment, the printing device takes as input the scanned image(s) data. For example, the printing device's marking engine may take as input a/an (un)compressed bitmap format, such as TIFF, where no conversion is required. In an alternative environment, the MFP driver converts the scanned image(s) data into a PDL format compatible with the printing device (e.g., PCL, Postscript).

In a third embodiment, the MFP driver may journal the scanned image(s) data for deferred playback into printer ready data (e.g., EMF in the Microsoft Operating systems). In an alternative embodiment, the MFP driver may allow the selecting of an alternative print driver(s) or MFP printing device(s).

In this style of system, the MFP firmware (driver 96) has clustering capabilities, and the ability to specify clustering options. Also, the MFP firmware has a command language for interpreting clustering options from the MFP driver, such as embedded in a print data stream (e.g., PJL).

The MFP driver sends the print data stream(s) along with the clustering options to the print spooler, for despooling to the specified MFP(s). For example, the user might have selected splitting one-hundred copies (i.e., Copy Splitting) of a scanned image evenly across two printers (e.g., fifty copies/printer) 92b and 94b. The MFP driver would augment the print data stream to include clustering commands for copy splitting evenly across printers 92b and 94b, which might look like:

| | |
|---|---|
| EscE | #Printer Reset |
| @PJT SET COPIES = 100 | #Number of Copies to Print |
| @PJL SET COPY SPLIT = ON | #Select Copy Splitting |
| @PJL SET LOAD BALANCE = EQUAL | #Distribute Print Job Equally |
| @PJL SET CLUSTER = “P1, P2” | #Printer Cluster |

The print spooler then passes the print data steam(s) to a print processor. If the print data stream(s) is printer ready data (i.e., RAW), the print data stream(s) is written directly to the port manager(s) of the specified MFP(s). If the print data stream(s) is journaled data, the print data stream(s) is played back to the respective MFP driver(s) of the specified MFP(s). The MFP driver then renders the journaled data into printer ready and passes it to the print spooler, and the print spooler writes the printer ready data directly to the port manager(s) of the specified MFP(s).

In the above example, the first MFP would send a modified copy of the print data stream(s) to the second MFP through a connection, such as a local, network, or remote, connection, and instructs the second MFP to print fifty copies, which might look like:

| | |
|---|---|
| ESC%-12345 | #Universal Printer Language Exit |
| ESCE | #Printer Reset |
| @PJL SET COPIES = 50 | #Number of Copies to Print |

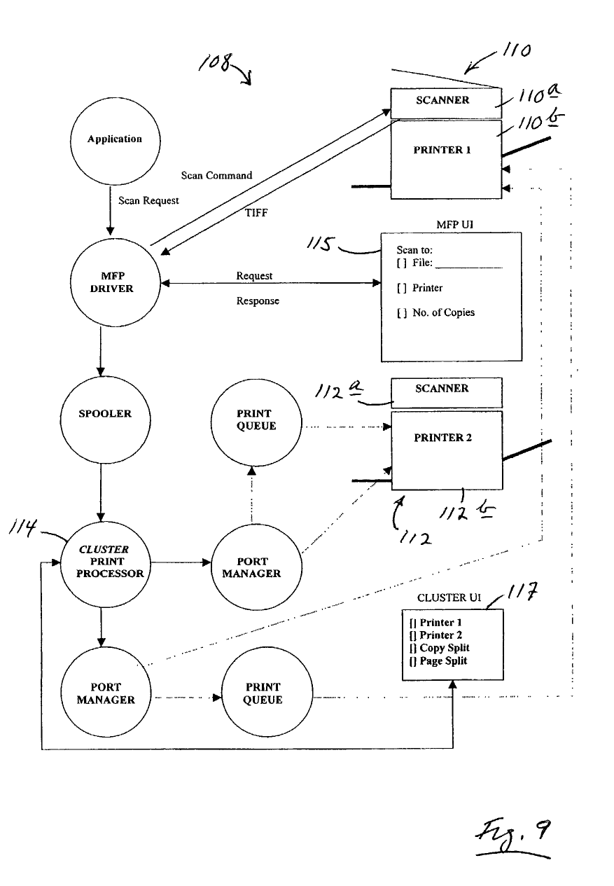

### The FIG. 8 Embodiment(s)

With focus now directed to FIG. 8 in the drawings, here there is shown generally at 100 what as referred to herein as a scan-to-cluster, MFP, cluster spooler based system. Included in this system are two MFP devices, shown at 102, 104, which include, respectively, scanners, or scanning devices, 102a, 104a, and printers, or print marking engines, 102b, 104b. Scanner 102a in MFP device 102 is what is employed by a user of system 100 to scan in documents for printing.

Interposed, in accordance with the present invention, in the data communication path which lies between scanner 102a, and the cluster of printers which includes printers 102b, 104b, is a cluster spooler shown at 106 in FIG. 8. Two user interfaces are shown at 107, 109.

In this embodiment, the user places the image(s) to be scanned on an MFP. The scanning unit of the MFP may be simplex or duplex, and may have a document feeder.

The user initiates a scan by invoking an MFP driver which contains both the scan driver and print driver for the corresponding MFP. The MFP scan driver reads from the scanner the scanned image(s) data (e.g., TIFF) which may be further manipulated by the driver to perform tasks such as cropping, zooming, rotating, compressing, color adjusting, and diffusing. In one embodiment, the MFP driver may further manipulate the scanned image(s) data. In another embodiment, the MFP driver may pass the scanned image(s) data to an application (e.g., Adobe PhotoShop) for further manipulation.

In another embodiment, the scanned image(s) data may be further manipulated by conversion into other compatible formats, such as JPEG and Raster Bitmaps, or translated, such as Optical Character Recognition (i.e., OCR), or segmented, such as text/image separation (i.e., Banding) and color/b&w separation (i.e., Color Collating).

The MFP printer driver converts the post-manipulation scanned image(s) data into printer ready data for the specified device(s). In one embodiment, the printing device takes as input the scanned image(s) data. For example, the printing device's marking engine may take as input a/an (un)compressed bitmap format, such as TIFF, where no conversion is required. In an alternative environment, the MFP driver converts the scanned image(s) data into PDL format compatible with the printing device (e.g., PCL, Postscript).

In a third embodiment, the MFP driver may journal the scanned image(s) data for deferred playback into printer ready data (e.g., EMF in the Microsoft Operating systems). In an alternative embodiment, the MFP driver may allow the selecting of an alternative print driver(s) of MFP printing device(s).

The printer ready data from the printer driver is then sent to the cluster print spooler (106) for despooling to MFP(s).

Here, as can be seen, spooler 106 has printer clustering capabilities (Cluster Spooling) and displays a dialog. Clustering capabilities may include copy splitting, job splitting, job separating, load balancing, intelligent routing, printer error recovering and job relocating.

The spooler displays to the user a dialog for selecting one or more printing device(s) and cluster options. In other embodiments, the cluster options and printing device(s) may be pre-configured, or set by an application, or automated process, or be made responsive to commands in the input data stream.

The cluster spooler modifies the print data stream according to the cluster, and routes the modified print data stream(s) to the specified MFP(s). For example, the user might have selected splitting one-hundred copies (i.e., Copy Splitting) of a scanned image evenly across to MFP printers (e.g., fifty copies MFP) 102b and 104b. The spooler could modify the print data stream to print fifty copies, and then send the same print data stream to both MFP printers 102b and 104b. The modified print data stream(s) could either be written to the port manager(s) of the specified MFPs, or passed onto to a print processor, which would write the print data stream(s) to the port manager(s) (i.e., printer ready data), or if journaled data, played back the print data stream(s) to the corresponding printer driver(s), which would subsequently render the journaled data into printer ready data, and pass to the print spooler for despooling to the specified MFP(s).

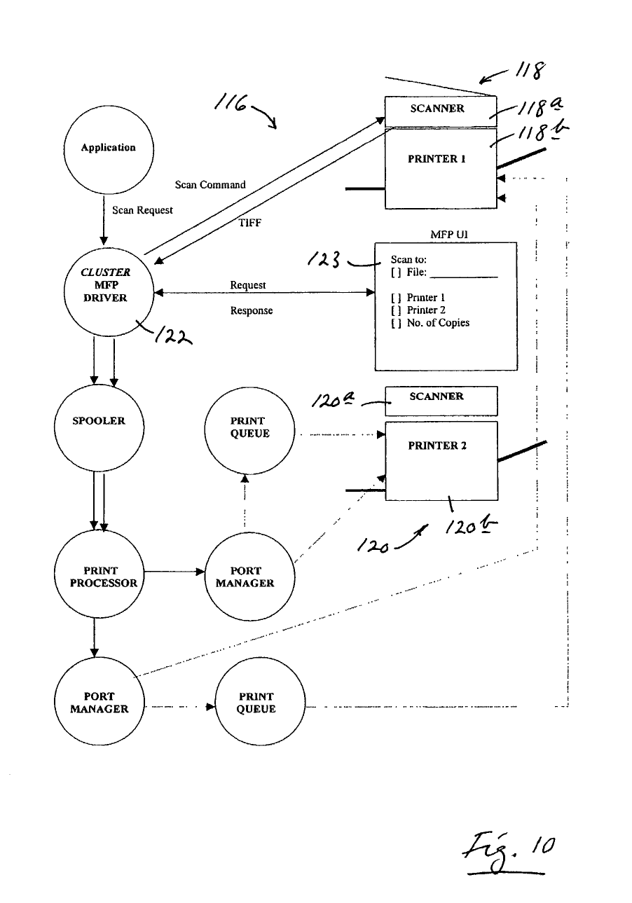

### The FIG. 9 Embodiment(s)

FIG. 9 shows at 108 a scan-to-cluster, MFP print processor based system made and operable in accordance with the present invention. System 108, as was true with respect to previously described systems 82, 90 and 100, employs two MFP devices, one of which is shown at 110, and the other of which is shown at 112. Included within MFP devices 110, 112, respectively, are scanners, or scanning devices, 110a, 112a, and printers, or print marking engines, 110b, 112b. It is scanner 110a in system 108 which a user employs to scan in documents for printing.

Interposed as a cluster print-job distributor in system 108 is a cluster print processor 114 made and operating in accordance with the invention. Also included are two user interfaces 115, 117.

In this embodiment, the user places the image(s) to be scanned on MFP 110. The scanning unit of this MFP may be a simplex or duplex in nature, and may have a document feeder.

The user initiates a scan by invoking an MFP driver which contains both the scan driver and print driver for the corresponding MFP. The MFP scan driver reads from the scanner the scanned image(s) data (e.g., TIFF) which may be further manipulated by the driver to perform tasks such as cropping, zooming, rotating, compressing, color adjusting, and diffusing. In one embodiment, the MFP driver may further manipulate the scanned image(s) data. In another embodiment, the MFP driver may pass the scanned image(s) data to an application, (e.g., Adobe PhotoShop) for further manipulation.

In another embodiment, the scanned image(s) data may be further manipulated by conversion into other compatible formats, such as JPEG and Raster Bitmaps, or translated, such as Optical Character Recognition (i.e., OCR), or segmented, such as text/image separation (i.e., Banding) and color/b&w separation (i.e., Color Collating).

The MFP driver converts the post-manipulated scanned image(s) data into printer ready data for the specified printing device(s). In one embodiment, the printing device takes as input the scanned image(s) data. For example, the printing device's marking engine may take as input a/an (un)compressed bitmap format, such as TIFF, where no conversion is required. In an alternative environment, the MFP driver converts the scanned image(s)data into a PDL format compatible with the printing device (e.g., PCL, Postscript).

In a third embodiment, the MFP driver may journal the scanned image(s) data for deferred playback into printer ready data (e.g., EMF in the Microsoft Operating system). In an alternative embodiment, the MFP driver may allow the selecting of an alternative printer(s) driver or MFP printing device(s).

The printer ready data from the printer is then sent to a print spooler for despooling to the MFP(s). The print spooler then despools the print data stream to a print processor.

In this system style, the print processor (114) has printer clustering capabilities (Cluster Print Processor) and displays a dialog. Clustering capabilities may include copy splitting, job splitting, job separating, load balancing, intelligent routing, printer error recovering and job relocating.

The print processor displays to the user a dialog for selecting one or more printing device(s) and cluster options. In other embodiments, the cluster options and printing device(s) may be pre-configured, or set by an application, or automated process, or may be made responsive to commands in the input print data stream.

The print processor modifies the print data stream according to the cluster options, and routes the modified print data stream(s) to specified MFP(s). For example, the user might have selected splitting one-hundred copies (i.e., Copy Splitting) of a scanned image evenly across two MFP printers (e.g., fifty copies/MFP) 110b and 112b. The print processor could modify the print data stream to print fifty copies, and then send the same print data stream to both printers 110b and 112b. The modified print data stream(s) could either be written to the port manager(s) of the specified MFPs, or if journaled data, played back the modified print data stream(s) to the corresponding driver(s), which would subsequently render the journaled data into printer ready data and pass to the print spooler for despooling to the specified MFP(s).

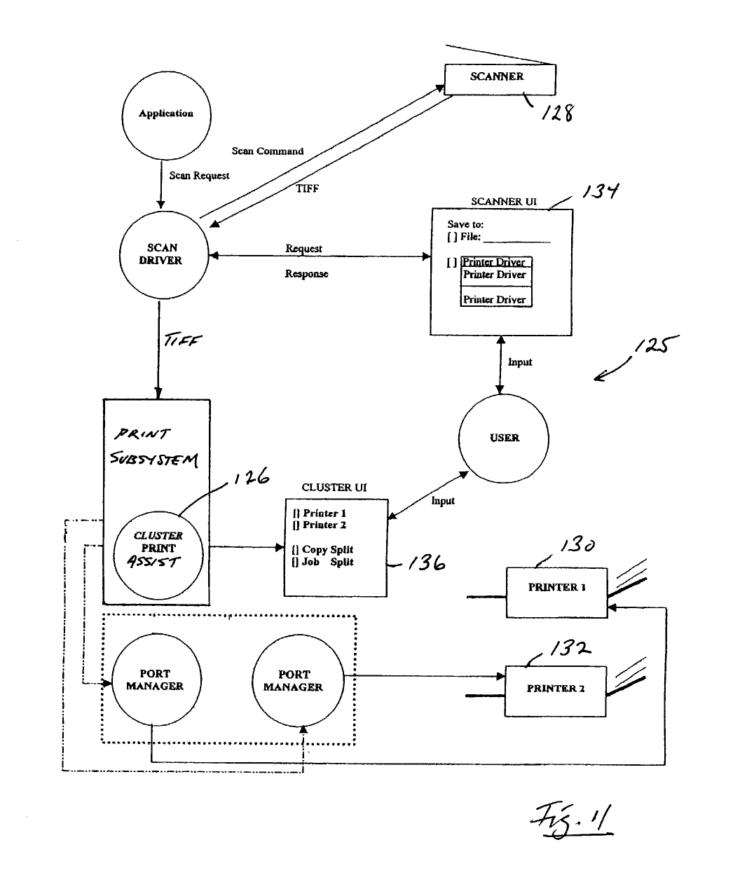

### The FIG. 10 Embodiment(s)

Finally, FIG. 10 in the drawings shows at 116 still another embodiment of the invention which is referred to herein as a scan-to-cluster MFP, MFP driver based system. Included in system 116 are two MFP devices, shown at 118, 120, which include, respectively, scanners, or scanning devices, 118a, 120a, and printers, or print marking engines, 118b, 120b, respectively.

In system 116, it is scanner 118a which functions as the device for scanning in documents for printing, and printers 118b, 120b which form the cluster of printers to which print jobs are distributively shared in accordance with practice of the invention with system 116.

Operating in system 116 as a cluster print-job distributor between scanner 118a and printers 118b, 120b is a cluster MFP driver 122 made and performing in accordance with the present invention. Also included in system 116 is a user interface 123.

In this embodiment, the user places the image(s) to be scanned on MFP 118. The scanning unit of this MFP may be a simplex or duplex type, and may have a document feeder.

The user initiates a scan by invoking cluster MFP driver 122 which contains both the scan driver and print driver for the corresponding MFP. The MFP driver reads from the scanner the scanned image(s) data (e.g., TIFF) which may be further manipulated by the driver to perform tasks such as cropping, zooming, rotating, compressing, color adjusting, and diffusing. In one embodiment, the MFP driver may further manipulate the scanned image(s) data. In another embodiment, the MFP driver may pass the scanned image(s) data to an application (e.g. Adobe PhotoShop) for further manipulation.

In another embodiment, the scanned image(s) data may be further manipulated by conversion into other compatible formats, such as JPEG and Raster Bitmaps, or translated, such as Optical character Recognition (i.e., OCR), or segmented, such as text/image separation (i.e. Banding) and color/b&w separation (i.e., Color Collating).

The MFP driver converts the post-manipulated scanned image(s) data into printer ready data for the specified printing device(s). In one embodiment the printing device takes as input the scanned image(s) data. For example, the printing device's marking engine may take as input a/an (un) compressed bitmap format, such as TIFF, where no conversion is required. In an alternative environment, the MFP driver converts the scanned image(s) data into a PDL format compatible with the printing device (e.g., PCL, Postscript).

In a third embodiment, the MFP driver may journal the scanned image(s) data for deferred playback into printer ready data (e.g. EMF in the Microsoft Operating systems). In an alternate embodiment, the MFP driver may allow the selecting of an alternative printer(s) driver or MFP device(s).

In this version of the invention, the MFP driver (122) has printer clustering capabilities (Cluster MFP Driver) and displays a dialog. Clustering capabilities may include copy splitting, job splitting, job separating, load balancing, intelligent routing, printer error recovering and job relocating.

The MFP driver displays to the user a dialog for selecting one or more (MFP(s) and cluster options. In other embodiments, the cluster options and MFP(s) may be pre-configured, or set by an application, or automated process, or be made to respond to embedded commands in the input scanned image(s) data.

The MFP driver modifies the scanned image(s) or print data stream according to the cluster options, and routes the modified scanned image(s) print data stream to the specific MFP(s). For example, the user might have selected splitting one-hundred copies (i.e., Copy Splitting) of scanned image evenly across two MFP printers (e.g., fifty copies/MFP) 118b and 120b. The MFP driver could modify the scanned image(s)/print data stream to print fifty copies, and then send the same scanned image(s) print data stream to both MFP printers 118b and 120b. The MFP driver(s) would render the scanned image(s) data into printer ready data, or handle journaled data for deferred playback, and pass the print data stream(s) to the print spooler for despooling to MFP printers 118b and 120b.

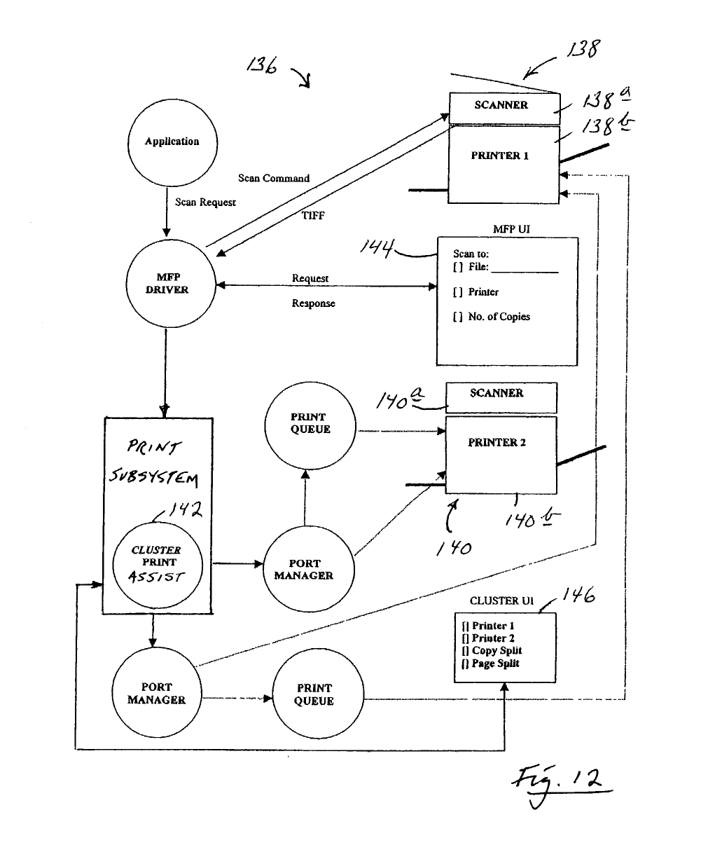

### The FIG. 11 Embodiment(s)

In this figure, there is shown at 125 a scan-to-cluster, stand-alone scanner system which employs a cluster print assist 126 configured in accordance with the invention. Also included in system 125 are a stand-alone scanner 128, two printers 130, 132, and two user interfaces, shown at 134, 136. Cluster print assist 126 sits in the data communication path which extends between the scanner, the scan driver and the two printers.

From the organizational system details which are presented in FIG. 11, viewed in light of the various system operational arrangements and behaviors described above with regard to the other invention embodiments presented herein, it will be quite evident to those skilled in the are how system 125 performs.

It should be understood that the block in FIG. 11 which is labeled “PRINT SUBSYSTEM”, and which contains cluster print assist 126, can represent a number of different, specific structural and functional arrangements that may be characterized by different forms of print assist organizations.

### The FIG. 12 Embodiment(s)

In this figure, shown at 136 is a scan-to-cluster multi-MFP system which includes two MFP devices 138, 140, and a cluster print assist 142 configured in accordance with the invention. MFPs 138, 140 include scanners, 138a, 140a, and printers 138b, 140b, respectively. Scanner 138a is employed herein to scan documents for printing.

Also included in system 136 are two user interfaces, shown at 144, 146. Cluster print assist 126 sits in the data communication path which extends between the scanner and the printers.

As was stated just above in relation to FIG. 11, from the organizational system details which are presented in FIG. 12, taken along with various system behaviors and constructions described above with regard to the other invention embodiments presented herein, it will be clear to those skilled in the art how the system 136 performs. It should thus be apparent that the system and methodology proposed, and made available by, the present invention offer a unique solution to the distribution of scanned-in prints jobs for sharing to and by a plurality of network-available printers which become organized into an operative cluster of printers in accordance with practice of the invention. By furnishing a system, in accordance with the invention, wherein, somewhere in the data communication path between an input scanning device and a cluster of network-available printers there is provided at least one of (a) a cluster scan driver, (b) a cluster print driver, (c) a cluster spooler, (d) a cluster print processor, (e) a cluster MFP driver, or (f) a print assistant, an easy and reliably implementable approach is afforded for distributing large scanned-in print jobs to available network printing resources.

It is very apparent from the description which is given above, and from the sizeable number of illustrations which are presented in the drawing figures herein, that a large number of specific detailed embodiments of the invention are available which can differentiate in many different ways just exactly how a large print job gets so distributed. For example, not all selected cluster printers need do exactly the same task as other printers in the selected cluster. Some can be employed to share the burden of handling a percentage, or a selected number, of the total number of pages to be printed. Some can be chosen to implement certain image manipulations, and others not to do this. And so on, in a manner which very conveniently offers a system user a wide range of options to complete large scanned-in print jobs in a very effective and efficient manner.

Accordingly, while numerous overall preferred embodiments and methodologies proposed by the present invention are disclosed and described herein, along with a large number of recognizably useable and interesting embodiments, other variations and modifications in the system and methodology of this invention are understood to be possible, and to come within the scope of the following claims.

I claim:

1. In a document-printing setting, an organization comprising
a document scanning device,
plural, potentially available printing devices connectable to said scanning device, operable when so connected to print a document print job which has been scanned by the scanning device, and
disposed operatively and connectively intermediate said scanning device and said printing devices, a cluster print-job distributor operable to distribute, for sharing by two or more of said printing devices, divided portions of the document print job, said distributor taking the form of at least one of (a) a cluster scan driver, (b) a cluster print driver, (c) a cluster spooler, (d) a cluster print processor, (e) a cluster MFP driver, and (f) a cluster print assist.

2. The organization of claim 1, wherein said distributor is effective to enable at least one of (a) document image manipulation and (b) document image formatting.

3. The organization of claim 2, wherein such enablement can be differentiated for different printing devices.

4. The organization of claim 1, wherein said distributor specifically takes the form of a cluster scan driver, and which further comprises a user interface operatively connected to said cluster scan driver, effective to enable user invocation of cluster printing.

5. The organization of claim 1, wherein said distributor specifically takes the form of a cluster print driver, and which further comprises a user interface operatively connected to said cluster print driver, effective to enable user invocation of cluster printing.

6. The organization of claim 1, wherein said distributor specifically takes the form of a cluster spooler, and which further comprises a user interface operatively connected to said cluster spooler, effective to enable user invocation of cluster printing.

7. The organization of claim 1, wherein said distributor specifically takes the form of a cluster print processor, and which further comprises a user interface operatively connected to said cluster print processor, effective to enable user invocation of cluster printing.

8. The organization of claim 1, wherein said distributor specifically takes the form of a cluster MFP driver, and which further comprises a user interface operatively connected to said cluster MFP driver, effective to enable user invocation of cluster printing.

9. The organization of claim 1, wherein said distributor specifically takes the form of a cluster print assist, and which further comprises a user interface operatively connected to said cluster print assist, effective to enable user invocation of cluster printing.

10. The organization of claim 1 which further includes a user interface operatively and effectively connectable to said distributor for enabling user invocation of distribution behavior by that distributor.

11. A plural-printer, cluster-invoking, document-printing method which is employed during a print-job procedure involving an organization that includes a document scanning device and two or more capable printing devices, said method comprising
at a point communicatively intermediate the document scanning device and the printing devices, introducing a cluster print-job distributor which takes the form of at least one of (a) a cluster scan driver, (b) a cluster print driver, (c) a cluster spooler, (d) a cluster print processor, (e) a cluster MFP driver, and (f) a cluster print assist, and
enabling user invocation, as a part of the print-job procedure, of that print-job distributor.

12. The method of claim 11, wherein the provided distributor takes the form specifically of a cluster scan driver, and wherein the method further comprises furnishing a user interface through which a user can selectively invoke that driver.

13. The method of claim 11, wherein the provided distributor takes the form specifically of a cluster print driver, and wherein the method further comprises furnishing a user interface through which a user can selectively invoke that driver.

14. The method of claim 11, wherein the provided distributor takes the form specifically of a cluster spooler, and wherein the method further comprises furnishing a user interface through which a user can selectively invoke that spooler.

15. The method of claim 11, wherein the provided distributor takes the form specifically of a cluster print processor, and wherein the method further comprises furnishing a user interface through which a user can selectively invoke that print processor.

16. The method of claim 11, wherein the provided distributor takes the form specifically of a cluster MFP driver, and wherein the method further comprises furnishing a user interface through which a user can selectively invoke that driver.

17. The method of claim 11, wherein the provided distributor takes the form specifically of a cluster print assist, and wherein the method further comprises furnishing a user interface through which a user can selectively invoke that assist.
